(19) United States
(12) Patent Application Publication
(10) Pub. No.: US 2012/0242712 A1
(43) Pub. Date: Sep. 27, 2012

(54) PIXEL CIRCUIT OF LIGHT EMITTING DIODE DISPLAY AND DRIVING METHOD THEREOF

(75) Inventors: CHIEN-CHUAN KO, Changhua (TW); Chao-hui Wu, Kaohsiung (TW)

(73) Assignee: Hannstar Display Corporation, New Taipei City (TW)

(21) Appl. No.: 13/366,262

(22) Filed: Feb. 3, 2012

(30) Foreign Application Priority Data
Mar. 24, 2011 (TW) 100110224

(51) Int. Cl. G09G 3/32; G09G 5/10; G09G 5/00

(52) U.S. Cl. 345/690; 345/76; 345/77; 345/212

(57) ABSTRACT

The gate of the first TFT in the present invention is discharged through the first TFT and the OLED in the compensation and data writing stage operation. As in cases that the usage time of the display pixel extends and the threshold voltage of the first TFT increases and the mobility thereof decreases, the voltage of the OLED increases, or the size of the display becomes larger to induce IR drop, the present invention enables to reduce the discharge voltage (charge current) to raise the gate voltage of the first TFT for compensating the OLED current drop. Meanwhile, the fifth TFT has characteristic of the threshold voltage increase. As the threshold voltage of the fifth TFT increases with usage time, the compensation of the OLED luminous efficiency drop can be realized.

### BACKGROUND OF THE INVENTION

1. Field of the Invention

The present invention generally relates to a pixel circuit of a light emitting diode display, and more particularly to a pixel circuit of a light emitting diode (LED) display and a driving method thereof for totally solving issues of LED current drop, luminous efficiency drop and IR drop due to the larger size of the display.

2. Description of Prior Art

The LCD is the mainstream of display technology. However, the OLED display is considered to replace the LCD by related industry and is going to be the next generation display. Comparing with the LCD, the OLED display possesses tons of advantages. For example, self lighting, wide view angle, rapid response time, high brightness, high luminous efficiency, low operating voltage, thin panel, flexibility, few processes, low cost and et cetera.

However, the biggest difference between the OLED and the LCD is that the brightness of the OLED is determined by the current. Therefore, for precisely determining the brightness of the pixel requires to precisely controlling the current I_{OLED}. Comparing with the LCD which merely requires the exact control to the voltage level of the pixel for determining the brightness, the precise control to the current I_{OLED} is much difficult.

Please refer to FIG. 1 and FIG. 2. FIG. 1 depicts a diagram of an OLED pixel circuit having a P type thin film transistor for driving an OLED pixel according to prior art. FIG. 2 depicts a diagram of an OLED pixel circuit having an N type thin film transistor for driving an OLED pixel according to prior art. As shown in figures, the pixel of the OLED display generally comprises a driving thin film transistor T2 and storage capacitance Cst to proceed the brightness control to the OLED. The voltage V_{GS} of the storage capacitance Cst is provided to the thin film transistor T2 for the brightness control. Regarding of the N type thin film transistor T2 shown in FIG. 2, the current of the organic light emitting diode (OLED) can be derived from the equation below:

I_{OLED}=½*W/L*μ_{N}*C_{OX}(V_{GS}−V_{TH})² (equation 1)

C_{OX} represents the unit-area capacitance. W and L represent the width and the length of the thin film transistor T2. I_{OLED} represents the current as a voltage V_{data} is supplied to the thin film transistor T2. When the usage time of the OLED extends, some reasons why the I_{OLED} in the foregoing formula changes are: the threshold voltage V_{TH} of the thin film transistor T2 increases or the mobility μ_{N} decreases. Then, the I_{OLED} drops and leads to the brightness decay of the OLED.

Furthermore, the material of the OLED certainly ages after the long usage time. The voltage of the OLED increases and the luminous efficiency of the OLED drops. The increase of the OLED voltage also can affect the operation of the thin film transistor. Such as the N type thin film transistor T2 shown in FIG. 2, the OLED is coupled to the source of the thin film transistor T2. As the voltage of the OLED increases, the voltage between the gate and the source of the thin film transistor T2 is changed. Therefore, the current flowing through the thin film transistor T2 is will be directly affected.

Furthermore, the luminous efficiency of the OLED drops because the material of the OLED certainly ages after the long usage time. Due to the luminous efficiency drop, even the same current flowing through the OLED, the expected brightness cannot be realized. Besides, the luminous efficiency drops of the tricolor are different and more serious issue of the color cast occurs.

Moreover, with the size of the display becomes larger, an IR drop issue occurs. Please refer to FIG. 3, which depicts a diagram of showing the IR drop due to the voltage difference generated by the internal resistance of the longer signal lines in the larger size of the AMOLED display and an unstable current of the pixel circuit caused by the IR drop. When the size of the display becomes larger, the lengths of the signal lines V_{DD} and V_{SS} have to be increased. Accordingly, the internal resistance effect occurs to generate the voltage difference. As shown in FIG. 3, the voltage of the pixel at the left side of the display is V_{DD} because it is closer to the scan line driving source. However, with the signal line extends toward the right side of the display, the internal resistance ΔR exists. Therefore, the voltage of the pixels at the right side of the display is V_{DD}−I_{DD}×ΔR. Similarly, the voltage of the pixels at the left side of the display is V_{SS} because it is closer to the scan line driving source. With the signal line extends toward the right side of the display, the internal resistance ΔR exists. Therefore, the voltage of the pixel at the right side of the display is V_{SS}+I_{SS}×ΔR. As aforementioned, the voltages V_{DD} and V_{SS} are different at the different locations of the display without the consideration that the internal resistance effect. Consequently, the pixels at the different locations of the AMOLED display will have different currents I_{OLED}. The brightness of the AMOLED display cannot be uniformed.

Consequently, there is a need to develop a pixel circuit of a light emitting diode (LED) display and a driving method thereof for totally solving issues of the LED current drop, the luminous efficiency drop and the IR drop due to the larger size of the display.

### SUMMARY OF THE INVENTION

An objective of the present invention is to provide a pixel circuit of a light emitting diode (LED) display and a driving method thereof to totally solve the issues the LED current drop, the luminous efficiency drop and the IR drop due to the larger size of the display.

For realizing the aforesaid objective, the present invention provides a pixel circuit of a light emitting diode display. The light emitting diode display has a data line, an emit line and a scan line, respectively coupled to the pixel circuit and has an operating voltage and a grounding voltage provided to the pixel circuit. The pixel circuit of the light emitting diode display comprises: a first thin film transistor, employed as being a driving thin film transistor and having a first end and a second end, and the first end of the first thin film transistor is source; a light emitting diode, having a first end and a second end, and the first end of the light emitting diode is anode to be coupled to the first end of the first thin film transistor to be driven by the first thin film transistor; a second thin film transistor, having a first end and a second end, and a gate of the second thin film transistor is coupled to the emit line and the first end of the second thin film transistor is supplied with the operating voltage, and the second end of the second thin film transistor is coupled to the second end of the first thin film transistor where a first node is formed therebetween; a third thin film transistor, having a first end and a second end, and a gate of the third thin film transistor is coupled to the scan line, and the first end of the third thin film transistor is coupled to the first node, and the second end of the third thin film transistor is coupled to a gate of the first thin film transistor where a second node is formed therebetween; a fourth thin film transistor, having a first end and a second end, and a gate of the fourth thin film transistor is coupled to the scan line, and the first end of the fourth thin film transistor is coupled to the data line to control an input interval of the data line; a fifth thin film transistor, having a first end and a second end, and a gate of the fifth thin film transistor is coupled to the emit line, and the first end of the fifth thin film transistor is coupled to the second end of the fourth thin film transistor where a third node is formed therebetween, and the second end of the fifth thin film transistor is coupled to the second end of the light emitting diode; and a compensation capacitance, having a first end and a second end, and the first end of the compensation capacitance is coupled to the third node, and the second end of the compensation capacitance is coupled to the second node; wherein the second thin film transistor initializes voltage levels of the first node and the second node to be maintained at the operating voltage, and the third thin film transistor saves a compensation voltage of the second node in the compensation capacitance, and the fifth thin film transistor constantly discharges to the first end of the compensation capacitance to maintain a voltage level of the third node.

The present invention provides another pixel circuit of a light emitting diode display. The pixel circuit of the light emitting diode display comprises a first thin film transistor, employed as being a driving thin film transistor and having a first end and a second end, and the first end of the first thin film transistor is source; a light emitting diode, having a first end and a second end, and the first end of the light emitting diode is supplied with the operating voltage, and the second end of the light emitting diode is cathode to be coupled to the first end of the first thin film transistor to be driven by the first thin film transistor; a second thin film transistor, having a first end and a second end, and a gate of the second thin film transistor is coupled to the emit line and the first end of the second thin film transistor is supplied with the grounding voltage, and the second end of the second thin film transistor is coupled to the second end of the first thin film transistor where a first node is formed therebetween; a third thin film transistor, having a first end and a second end, and a gate of the third thin film transistor is coupled to the scan line, and the first end of the third thin film transistor is coupled to the first node, and the second end of the third thin film transistor is coupled to a gate of the first thin film transistor where a second node is formed therebetween; a fourth thin film transistor, having a first end and a second end, and a gate of the fourth thin film transistor is coupled to the scan line, and the first end of the fourth thin film transistor is coupled to the data line to control an input interval of the data line; a fifth thin film transistor, having a first end and a second end, and a gate of the fifth thin film transistor is coupled to the emit line, and the first end of the fifth thin film transistor is coupled to the second end of the fourth thin film transistor where a third node is formed therebetween, and the second end of the fifth thin film transistor is coupled to the first end of the light emitting diode; and a compensation capacitance, having a first end and a second end, and the first end of the compensation capacitance is coupled to the third node, and the second end of the compensation capacitance is coupled to the second node; wherein the second thin film transistor initializes voltage levels of the first node and the second node to be maintained at the grounding voltage, and the third thin film transistor saves a compensation voltage of the second node in the compensation capacitance, and the fifth thin film transistor constantly charges to the first end of the compensation capacitance to maintain a voltage level of the third node.

Furthermore, the present invention also provides a driving method of a pixel, employed for a pixel circuit having a data line, an emit line and a scan line, respectively coupled to the pixel circuit and having an operating voltage and a grounding voltage provided thereto, and the pixel circuit comprising a first thin film transistor, a light emitting diode, a second thin film transistor, a third thin film transistor, a fourth thin film transistor, a fifth thin film transistor and a compensation capacitance, and a first end of the first thin film transistor is coupled to the first end of the light emitting diode to drive the light emitting diode, and a second end of the second thin film transistor is coupled to the second end of the first thin film transistor wherein a first node is formed therebetween, and a second end of the third thin film transistor is coupled to a gate of the first thin film transistor where a second node is formed therebetween, and a first end of the fifth thin film transistor is coupled to a second end of the fourth thin film transistor where a third node is formed therebetween, and a first end of the compensation capacitance is coupled to the third node, and a second end of the compensation capacitance is coupled to the second node, the driving method comprising steps of: providing the grounding voltage to the emit line and the scan line and conducting the first thin film transistor, the second thin film transistor, the third thin film transistor, the fourth thin film transistor and the fifth thin film transistor to initialize voltage levels of the first node and the second node to be maintained at the operating voltage; providing the operating voltage to the emit line and cutting off the second thin film transistor and the fifth thin film transistor to provide a pixel data voltage to the data line to make the first node and the second node are discharged through the first thin film transistor and the light emitting diode; and providing the operating voltage to the scan line and the grounding voltage to the emit line, and cutting off the third thin film transistor and the fourth thin film transistor, and conducting the second thin film transistor and the fifth thin film transistor to utilize the compensation capacitance for coupling the voltage level of the third node with the voltage level of the second node to be provided to the first thin film transistor for driving the light emitting diode.

In the present invention, the gate of the first thin film transistor (the second node) is discharged through the first thin film transistor and the light emitting diode in the compensation and data writing stage operation. The voltage V_{B} drops from V_{DD} to (V_{DD}−V_{Discharge}). As mentioned in formula 1, the threshold voltage V_{TH} of the first thin film transistor increases and the mobility μ_{N} decreases as the usage time of the display pixel extends, the size of the display becomes larger to induce IR drop and voltage V_{SS} becomes larger to induce the discharge current drop, the present invention is capable of decreasing the voltage V_{Discharge} and increases the voltage V_{B} and therefore compensating the I_{OLED} drop to prevent the brightness decrease of the OLED.

Moreover, the stress times of the first thin film transistor and the fifth thin film transistor are similar. Therefore, the characteristic of the threshold voltage increase exists for both. Because the threshold voltage increases with usage time, the compensation of the OLED luminous efficiency drop can be realized.

Consequently, the pixel circuit of a light emitting diode display and the driving method thereof according to the present invention is capable of totally solving the issues of the LED current drop, the luminous efficiency drop and the IR drop due to the larger size of the display and more beneficial to the development trend of larger size display in the future.

For a better understanding of the aforementioned content of the present invention, preferable embodiments are illustrated in accordance with the attached figures for further explanation:

### BRIEF DESCRIPTION OF THE DRAWINGS

FIG. 1 depicts a diagram of an OLED pixel circuit having a P type thin film transistor for driving an OLED pixel according to prior art.

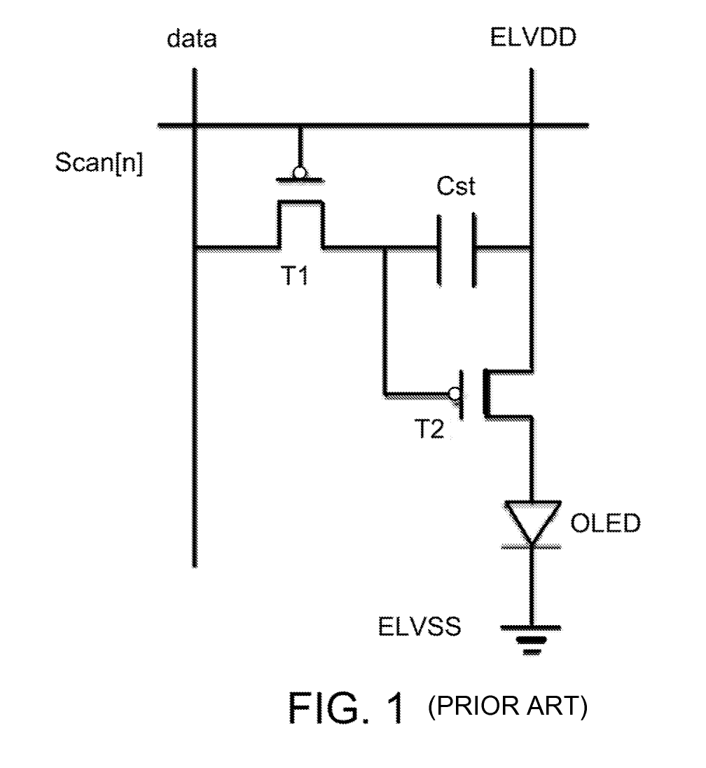

FIG. 2 depicts a diagram of an OLED pixel circuit having a N type thin film transistor for driving an OLED pixel according to prior art.

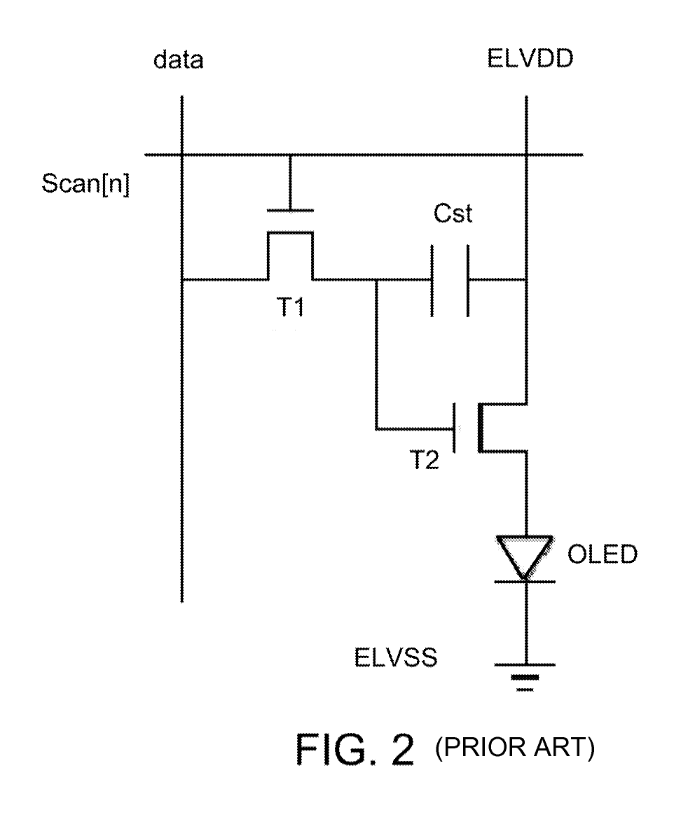

FIG. 3 depicts a diagram of showing an IR drop due to voltage difference generated by the internal resistance of the longer signal lines in the larger size of the AMOLED display and an unstable current of the pixel circuit caused by the IR drop.

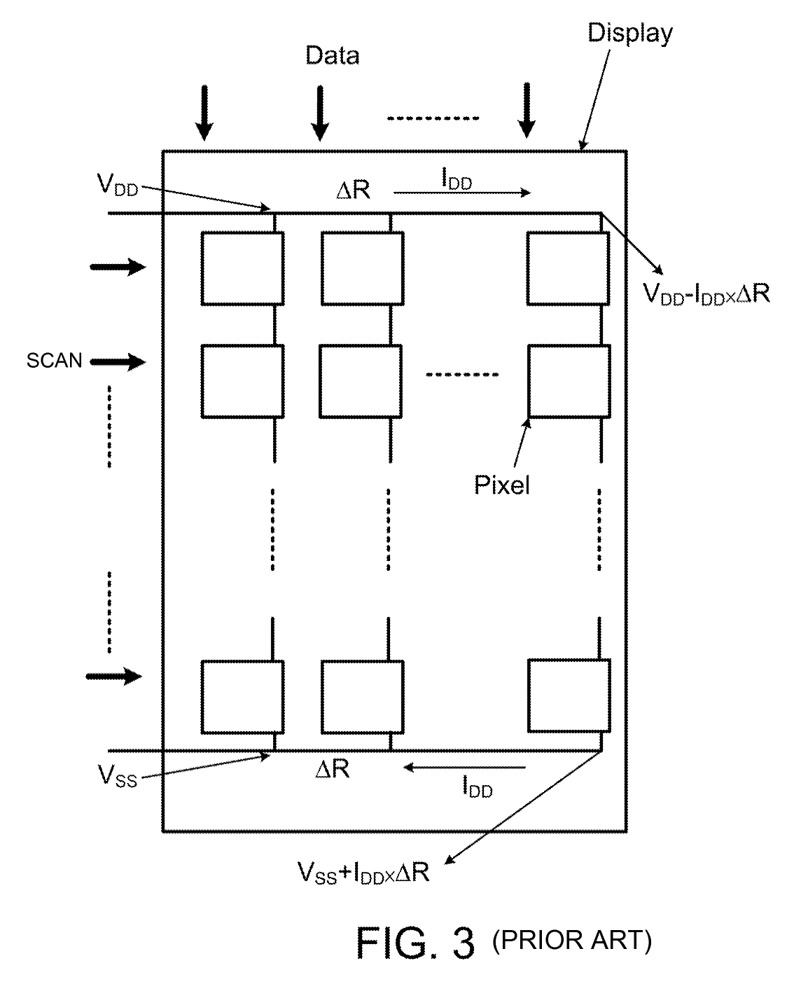

FIG. 4 depicts a diagram of a pixel circuit of an active matrix organic light emitting diode (AMOLED) display according to a first embodiment of the present invention.

FIG. 5 depicts a waveform diagram of signals for circuit operation of the pixel circuit of the first embodiment shown in FIG. 4.

FIG. 6 depicts a relationship diagram of I_{Discharge}, V_{TH}_{_{—}}_{T1}, V_{OLED}, V_{SS}, μ_{N} in the first embodiment of the present invention.

FIG. 7 depicts a diagram of a pixel circuit of an active matrix organic light emitting diode display according to a second embodiment of the present invention.

FIG. 8 depicts a waveform diagram of signals for circuit operation of the pixel circuit of the second embodiment shown in FIG. 7.

FIG. 9 depicts a relationship diagram of I_{Charge}, V_{DD}, V_{TH}_{_{—}}_{T1}, V_{OLED}, V_{SS}, μ_{P} in the second embodiment of the present invention.

### DETAILED DESCRIPTION OF THE INVENTION

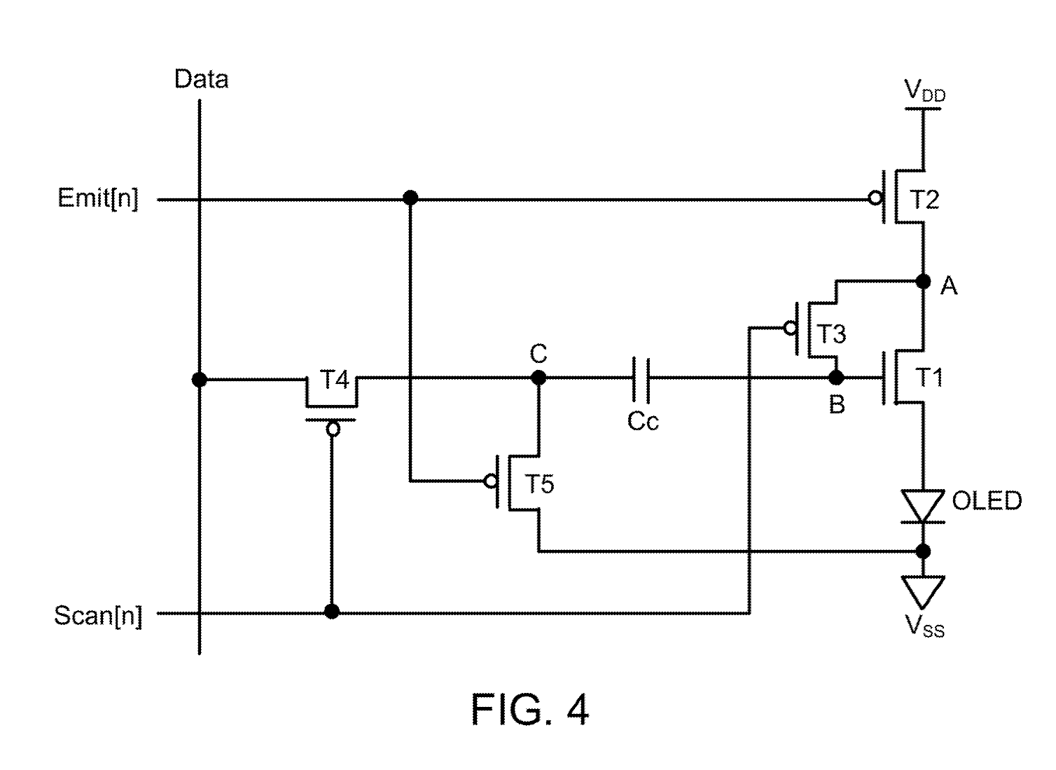

Please refer to FIG. 4, which depicts a diagram of a pixel circuit of an active matrix organic light emitting diode (AMOLED) display according to a first embodiment of the present invention. As shown in figures, the first thin film transistor is an N type thin film transistor. The second, third, fourth and fifth thin film transistors are P type thin film transistors. Meanwhile, the present invention does not need a storage capacitance Cst as in prior art. The light emitting diode display shown in FIG. 4 has a data line (Data), an emit line (Emit[n]) and a scan line (Scan[n]) coupled to the pixel circuit. The variable n represents the pixel is one among lots of pixels of the display. The light emitting diode display provides an operating voltage V_{DD} and a grounding voltage V_{SS} to the pixel circuit. The pixel circuit of the light emitting diode display comprises a first thin film transistor T1, an organic light emitting diode OLED, a second thin film transistor T2, a third thin film transistor T3, a fourth thin film transistor T4, a fifth thin film transistor T5 and a compensation capacitance Cc.

The first thin film transistor T1 is employed as being a driving thin film transistor of the organic light emitting diode and has a first end and a second end. The first end of the first thin film transistor T1 is source.

The organic light emitting diode has a first end and a second end. The first end of the organic light emitting diode is anode to be coupled to the first end of the first thin film transistor T1 to be driven by the first thin film transistor T1.

The second thin film transistor T2 has a first end and a second end. The gate of the second thin film transistor T2 is coupled to the emit line and the first end of the second thin film transistor T2 is supplied with the operating voltage V_{DD}. The second end of the second thin film transistor T2 is coupled to the second end of the first thin film transistor T1. A first node A is formed between the first thin film transistor T1 and the second thin film transistor T2.

The third thin film transistor T3 has a first end and a second end. The gate of the third thin film transistor T3 is coupled to the scan line. The first end of the third thin film transistor T3 is coupled to the first node A and the second end of the third thin film transistor T3 is coupled to the gate of the first thin film transistor T1. A second node B is formed between the first thin film transistor T1 and the third thin film transistor T3.

The fourth thin film transistor T4 has a first end and a second end. The gate of the fourth thin film transistor T4 is coupled to the scan line (Scan[n]). The first end of the fourth thin film transistor T4 is coupled to the data line (Data) to control an input interval of the data line (Data).

The fifth thin film transistor T5 has a first end and a second end. The gate of the fifth thin film transistor T5 is coupled to the emit line (Emit[n]). The first end of the fifth thin film transistor T5 is coupled to the second end of the fourth thin film transistor T4. A third node C is formed between the fourth thin film transistor T4 and the fifth thin film transistor T5. The second end of the fifth thin film transistor T5 is coupled to the second end of the organic light emitting diode.

The compensation capacitance Cc has a first end and a second end. The first end of the compensation capacitance Cc is coupled to the third node C and the second end of the compensation capacitance Cc is coupled to the second node B.

In the first embodiment, the gate of the first thin film transistor T1 (the second node B) is discharged through the first thin film transistor T1 and the organic light emitting diode in the compensation and data writing stage operation. Therefore, the voltage V_{A} of the first node A and the voltage V_{B} of the second node B are discharged and changed from V_{DD} to (V_{DD}−V_{Discharge}). As in cases that the usage time of the display pixel extends, the threshold voltage V_{TH} of the first thin film transistor T1 increases and the mobility μ_{N} decreases, the voltage of the organic light emitting diode increases, or the size of the display becomes larger to induce IR drop and voltage V_{SS} becomes larger and causes to induce the discharge current I_{Discharge} drop. In the aforementioned three scenarios, the I_{OLED} drop occurs and the brightness of the organic light emitting diode decrease. However, the present invention enables to decrease the voltage V_{Discharge} and increases the voltage V_{B}, and therefore to compensate the I_{OLED} drop. Moreover, stress times of the fifth thin film transistor T5 and the first thin film transistor T1 for driving the organic light emitting diode are similar. Therefore, the characteristic of the threshold voltage increase exists for both. Because the threshold voltage V_{TH}_{_{—}}_{T5} of the fifth thin film transistor T5 increases with usage time, the fifth thin film transistor T5 can compensate the OLED luminous efficiency drop.

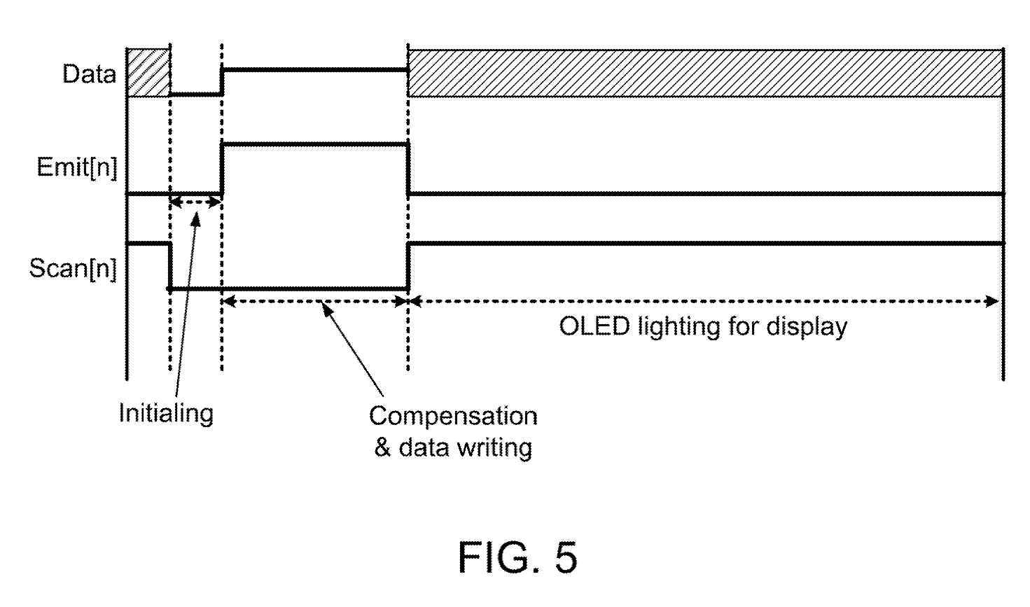

Please refer to FIG. 4 and FIG. 5. FIG. 5 depicts a waveform diagram of signals for circuit operation of the pixel circuit of the first embodiment shown in FIG. 4. As shown in the figure, driving the pixel of the present invention can be three stages, initializing stage, compensation and data writing stage, and OLED lighting stage. In the initial stage, the second thin film transistor T2 initializes voltage levels of the first node A and the second node B to be the operating voltage V_{DD} for conducting the first thin film transistor T1 for compensation in the coming compensation and data writing stage. The third thin film transistor T3 allows the first thin film transistor T1 to form a diode connection. The diode connection generates compensation voltage V_{B} at the second node B and saves a compensation voltage V_{B} in the compensation capacitance Cc. The fifth thin film transistor T5 is employed to constantly discharge to the first end of the compensation capacitance Cc to maintain the third node C at a voltage level V_{SS}+V_{TH}_{_{—}}_{T5} and to prevent the V_{Data} to be changed by the leak current of the fourth thin film transistor T4.

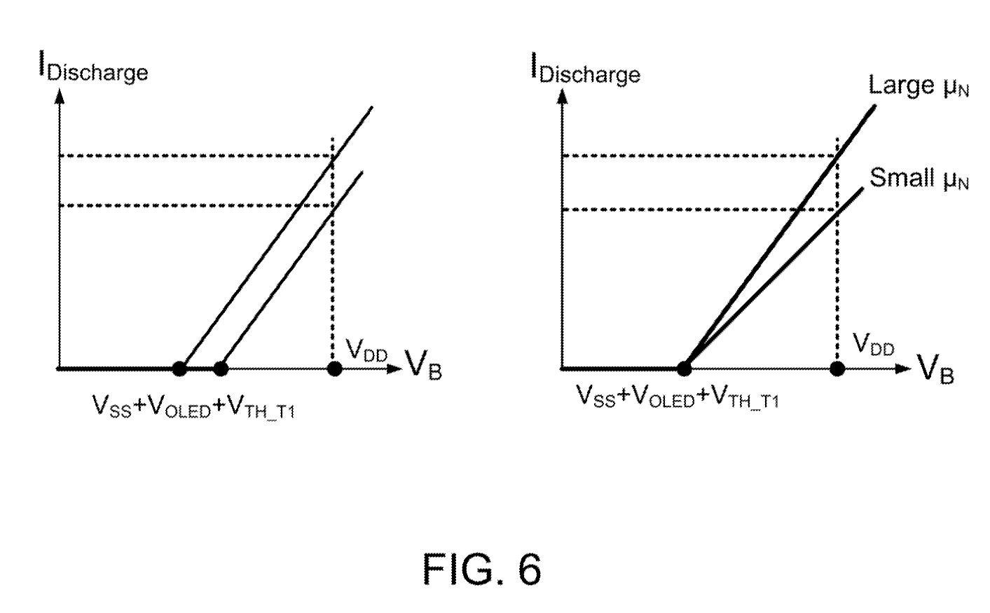

Please refer to FIG. 4, FIG. 5 and FIG. 6. FIG. 6 depicts a relationship diagram of I_{Discharge}, V_{TH}_{_{—}}_{T1}, V_{OLED}, V_{SS}, μ_{N} in the first embodiment of the present invention and further detailed explanation for the initializing stage, the compensation and data writing stage, and the OLED lighting stage is introduced below:

The initializing stage

providing the grounding voltage V_{SS} to the emit line (Emit[n]) and the scan line (Scan[n]) and conducting the first thin film transistor T1, the second thin film transistor T2, the third thin film transistor T3, the fourth thin film transistor T4 and the fifth thin film transistor T5 to initialize voltage levels of the first node A and the second node B to be maintained at the operating voltage V_{DD}. At this moment, the V_{Data} is V_{SS} and the voltage at the third node C is the smaller one of the V_{SS}+V_{TH}_{_{—}}_{T4} and V_{SS}+V_{TH}_{_{—}}_{T5};

The compensation and data writing stage

providing the operating voltage V_{DD} to the emit line (Emit[n]) and cutting off the second thin film transistor T2 and the fifth thin film transistor T5 to provide a pixel data voltage to the data line (Data). At this moment, the voltage V_{C} of the third node C becomes V_{Data}. The first node A and the second node B are discharged to the grounding voltage V_{SS} through the first thin film transistor T1 and the organic light emitting diode (OLED). The voltage V_{A} of the first node A and the voltage V_{B} of the second node B are changed from V_{DD} to V_{DD}−V_{Discharge}. Meanwhile, the discharge is controlled within a predetermined interval to prevent the first node A and the second node B discharged completely. With the incomplete discharge characteristic according to the present invention, the effect of the mobility μ_{N} drop can be compensated (complete discharge cannot compensate the mobility μ_{N} drop). Moreover, the incomplete discharge characteristic also can shorten the react time of the display in advance;

The OLED lighting stage

providing the operating voltage V_{DD} to the scan line (Scan[n]) and the grounding voltage V_{SS} to the emit line (Emit[n]), and cutting off the third thin film transistor T3 and the fourth thin film transistor T4, and conducting the second thin film transistor T2 and the fifth thin film transistor T5. The second node B becomes a floating status and the voltage V_{C} of the third node C is changed from V_{Data} to V_{SS}+V_{TH}_{_{—}}_{T5}. The compensation capacitance Cc is utilized and the voltage level V_{B} of the second node B becomes (V_{DD}−V_{Discharge})+[(V_{SS}+V_{TH}_{_{—}}_{T5})−V_{Data}] due to the capacitive coupling effect of the voltage level V_{C} of the third node C. Accordingly, the current of the organic light emitting diode (OLED) can be derived from the equation below:

$${V}_{Gate \_ T 1} = {V}_{B} = ( {V}_{DD} - {V}_{Discharge} ) + [ ( {V}_{SS} + {V}_{TH \_ T 5} ) - {V}_{Data} ] , \\ {V}_{source \_ T 1} = {V}_{SS} + {V}_{OLED} , \\ \begin{matrix}{I}_{OLED} = \frac{1}{2} * W / L * {μ}_{N} * {{C}_{OX} ( {V}_{GS \_ T 1} - {V}_{TH \_ T 1} )}^{2} \\ = \frac{1}{2} * W / L * {μ}_{N} * {C}_{OX} [ ( {V}_{DD} + {V}_{SS} ) - \\ ( {V}_{Discharge} + {V}_{TH \_ T 1} + {V}_{OLED} + {V}_{SS} ) + \\ { {V}_{TH \_ T 5} - {V}_{Data} ]}^{2}\end{matrix} \qquad ( equation 2 )$$

In the foregoing equation 2 of the current I_{OLED} of the organic light emitting diode, V_{TH}_{_{—}}_{T1} increase, μ_{N} decrease and V_{OLED} increases; V_{DD}+V_{SS} can remain as a constant without the effect of the IR drop. However, the IR drop affects V_{SS} to be increased. The present invention can drop the discharge current I_{Discharge} to decrease the discharge voltage V_{discharge}. Accordingly, the objective of compensating the current I_{OLED} can be realized. Consequently, the present invention can prevent the effect that the pixels at the different locations of the display have different currents I_{OLED} which is caused by the IR drop due to the larger size of the display. Furthermore, the present invention utilizes the characteristic that the threshold voltage V_{TH}_{_{—}}_{T5} of the fifth thin film transistor T5 increases with usage time, accordingly, the compensation of the OLED luminous efficiency drop can be realized.

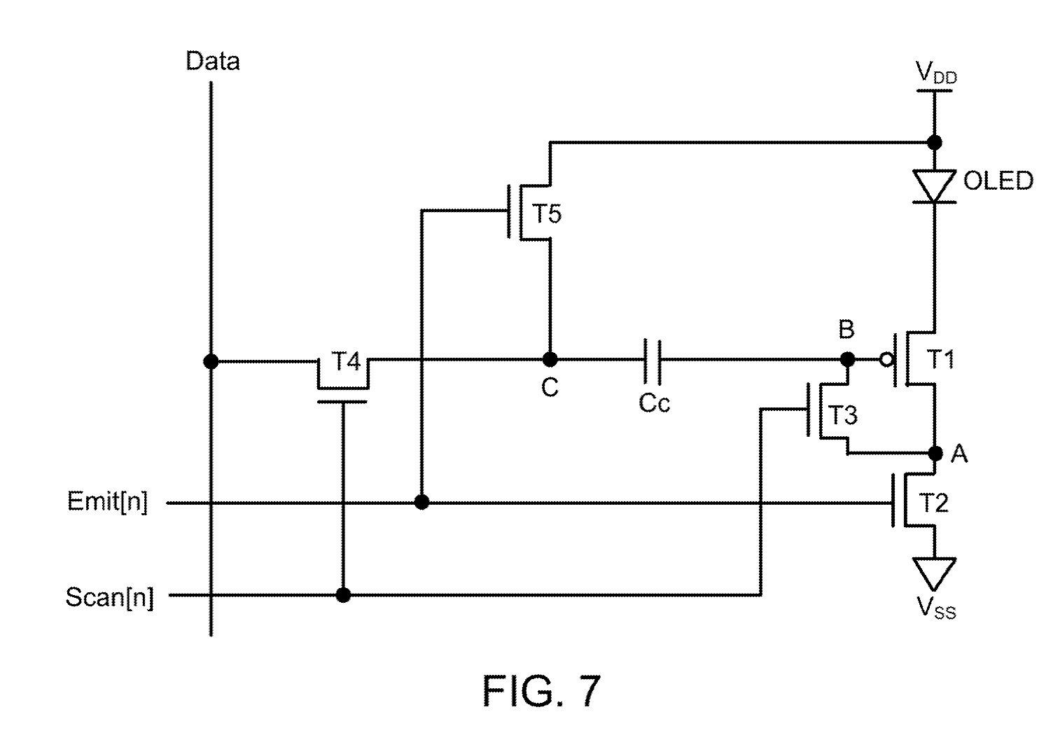

Please refer to FIG. 7, which depicts a diagram of a pixel circuit of an active matrix organic light emitting diode (AMOLED) display according to a second embodiment of the present invention. As shown in figures, the first thin film transistor is a P type thin film transistor. The second, third, fourth and fifth thin film transistors are N type thin film transistors. Meanwhile, the present invention does not need a storage capacitance Cst as in prior art. The light emitting diode display shown in FIG. 7 has a data line (Data), an emit line (Emit[n]) and a scan line (Scan[n]) coupled to the pixel circuit. The variable n represents the pixel is one among lots of pixels of the display. The light emitting diode display provides an operating voltage V_{DD} and a grounding voltage V_{SS} to the pixel circuit. The pixel circuit of the light emitting diode display comprises a first thin film transistor T1, an organic light emitting diode OLED, a second thin film transistor T2, a third thin film transistor T3, a fourth thin film transistor T4, a fifth thin film transistor T5 and a compensation capacitance Cc.

The first thin film transistor T1 is employed as being a driving thin film transistor of the organic light emitting diode OLED and has a first end and a second end. The first end of the first thin film transistor T1 is source.

The organic light emitting diode has a first end and a second end. The first end of the organic light emitting diode (OLED) is supplied with the operating voltage V_{DD}. The second end is cathode to be coupled to the first end of the first thin film transistor T1 to be driven by the first thin film transistor T1.

The second thin film transistor T2 has a first end and a second end. The gate of the second thin film transistor T2 is coupled to the emit line and the first end of the second thin film transistor T2 is supplied with the grounding voltage V_{SS}. The second end of the second thin film transistor T2 is coupled to the second end of the first thin film transistor T1. A first node A is formed between the first thin film transistor T1 and the second thin film transistor T2.

The third thin film transistor T3 has a first end and a second end. The gate of the third thin film transistor T3 is coupled to the scan line. The first end of the third thin film transistor T3 is coupled to the first node A and the second end of the third thin film transistor T3 is coupled to the gate of the first thin film transistor T1. A second node B is formed between the first thin film transistor T1 and the third thin film transistor T3.

The fourth thin film transistor T4 has a first end and a second end. The gate of the fourth thin film transistor T4 is coupled to the scan line (Scan[n]). The first end of the fourth thin film transistor T4 is coupled to the data line (Data) to control an input interval of the data line (Data).

The fifth thin film transistor T5 has a first end and a second end. The gate of the fifth thin film transistor T5 is coupled to the emit line (Emit[n]). The first end of the fifth thin film transistor T5 is coupled to the second end of the fourth thin film transistor T4. A third node C is formed between the fourth thin film transistor T4 and the fifth thin film transistor T5. The second end of the fifth thin film transistor T5 is coupled to the second end of the organic light emitting diode (OLED).

The compensation capacitance Cc has a first end and a second end. The first end of the compensation capacitance Cc is coupled to the third node C and the second end of the compensation capacitance Cc is coupled to the second node B. In the second embodiment, the gate of the first thin film transistor T1 (the second node B) is charged through the first thin film transistor T1 and the organic light emitting diode in the compensation and data writing stage operation. Therefore, the voltage V_{A} of the first node A and the voltage V_{B} of the second node B are charged and changed from V_{SS} to (V_{SS}+V_{Charge}). As in cases that the usage time of the display pixel extends, the threshold voltage V_{TH} of the first thin film transistor T1 increases and the mobility μ_{N} decreases, the voltage of the organic light emitting diode increases, or the size of the display becomes larger to induce IR drop and voltage V_{DD} becomes smaller and causes to induce the charge current I_{Charge} drop. In the aforementioned three scenarios, the I_{OLED} drop occurs and the brightness of the organic light emitting diode decrease. However, the present invention enables to decrease the voltage V_{Charge} and increases the voltage V_{B}, and therefore to compensate the I_{OLED} drop. Moreover, stress times of the fifth thin film transistor T5 and the first thin film transistor T1 for driving the organic light emitting diode are similar. Therefore, the characteristic of the threshold voltage increase exists for both. Because the threshold voltage V_{TH}_{_{—}}_{T5} of the fifth thin film transistor T5 increases with usage time, the fifth thin film transistor T5 can compensate the OLED luminous efficiency drop.

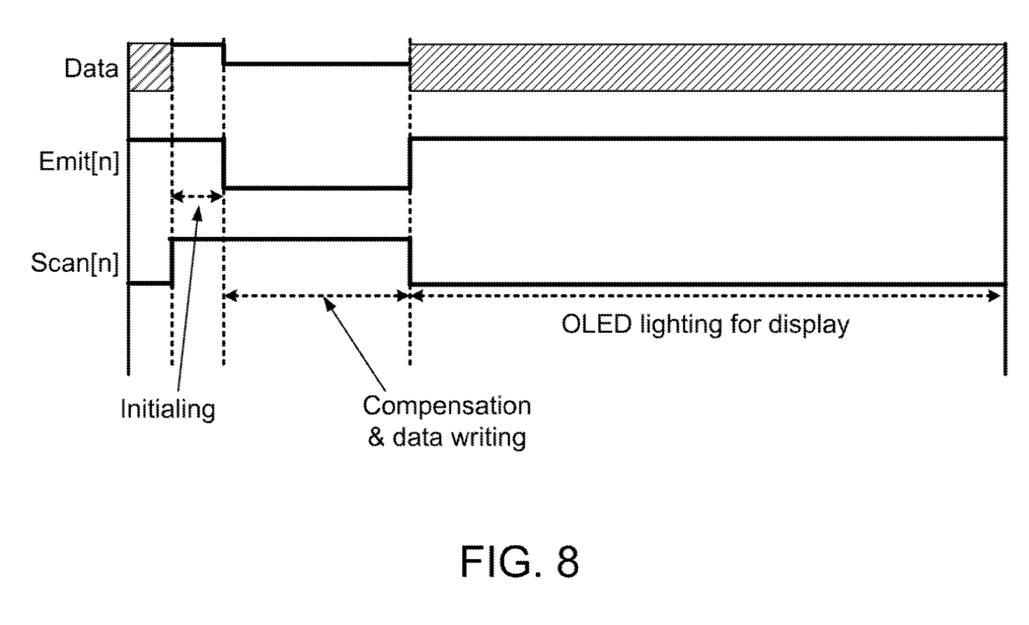

Please refer to FIG. 7 and FIG. 8. FIG. 8 depicts a waveform diagram of signals for circuit operation of the pixel circuit of the second embodiment shown in FIG. 7. As shown in the figure, Driving the pixel of the present invention can be three stages, initializing stage, compensation and data writing stage, and OLED lighting stage. In the initial stage, the second thin film transistor T2 initializes voltage levels of the first node A and the second node B to be the grounding voltage V_{SS} for conducting the first thin film transistor T1 for compensation in the coming compensation and data writing stage. The third thin film transistor T3 allows the first thin film transistor T1 to form a diode connection. The diode connection generates compensation voltage V_{B} at the second node B and saves a compensation voltage V_{B} in the compensation capacitance Cc. The fifth thin film transistor T5 is employed to constantly charge to the first end of the compensation capacitance Cc to maintain the third node C at a voltage level V_{SS}−V_{TH}_{_{—}}_{T5} and to prevent the V_{Data} to be changed by the leak current of the fourth thin film transistor T4.

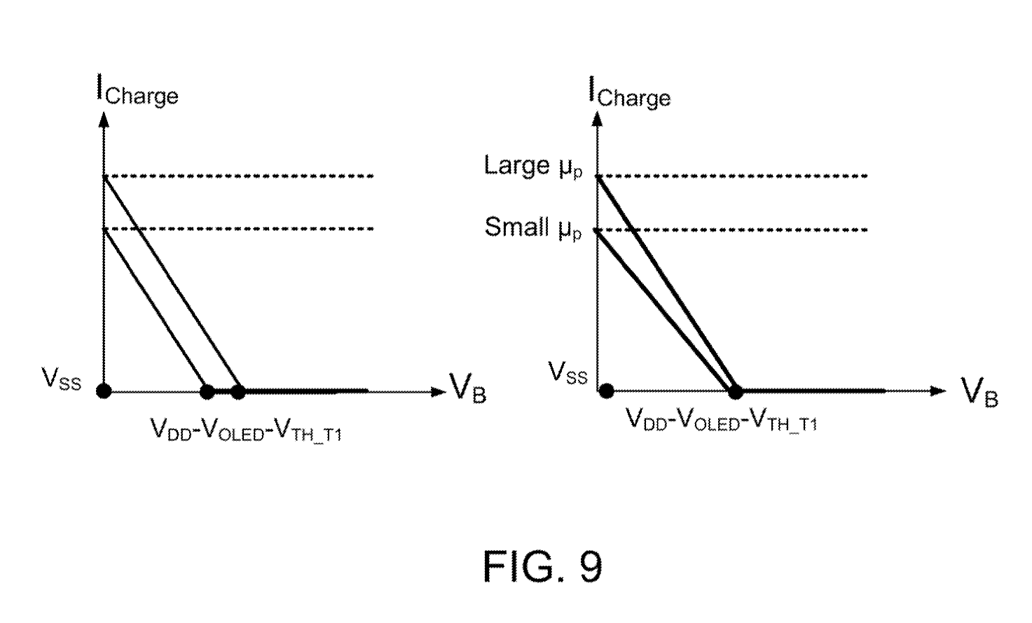

Please refer to FIG. 7, FIG. 8 and FIG. 9. FIG. 9 depicts a relationship diagram of I_{Charge}, V_{DD}, V_{TH}_{_{—}}_{T1}, V_{OLED}, V_{SS}, μ_{P} in the second embodiment of the present invention and further detailed explanation for the initializing stage, the compensation and data writing stage, and the OLED lighting stage is introduced below:

The initializing stage

providing the operating voltage V_{DD} to the emit line (Emit[n]) and the scan line (Scan[n]) and conducting the first thin film transistor T1, the second thin film transistor T2, the third thin film transistor T3, the fourth thin film transistor T4 and the fifth thin film transistor T5 to initialize voltage levels of the first node A and the second node B to be maintained at the grounding voltage V_{SS}. At this moment, the V_{Data} is V_{SS} and the voltage at the third node C is the smaller one of the V_{SS}−V_{TH}_{_{—}}_{T4} and V_{SS}−V_{TH}_{_{—}}_{T5};

The compensation and data writing stage

providing the grounding voltage V_{SS} to the emit line (Emit[n]) and cutting off the second thin film transistor T2 and the fifth thin film transistor T5 to provide a pixel data voltage to the data line (Data). At this moment, the voltage V_{C} of the third node C becomes V_{Data}. The first node A and the second node B are charged to the operating voltage V_{DD} through the first thin film transistor T1 and the organic light emitting diode (OLED). The voltage V_{A} of the first node A and the voltage V_{B} of the second node B are changed from V_{SS} to V_{SS}−V_{Charge}. Meanwhile, the charge is controlled within a predetermined interval to prevent the first node A and the second node B charged completely. With the incomplete charge characteristic according to the present invention, the effect of the mobility μ_{P} drop can be compensated (complete charge cannot compensate the mobility μ_{P} drop). Moreover, the incomplete charge characteristic also can shorten the react time of the display in advance;

The OLED lighting stage

providing the grounding voltage V_{SS} to the scan line (Scan[n]) and the operating voltage V_{DD} to the emit line (Emit[n]), and cutting off the third thin film transistor T3 and the fourth thin film transistor T4, and conducting the second thin film transistor T2 and the fifth thin film transistor T5. The second node B becomes a floating status and the voltage V_{C} of the third node C is changed from V_{Data} to V_{SS}−N_{TH}_{_{—}}_{T5}. The compensation capacitance Cc is utilized and the voltage level V_{B} of the second node B becomes (V_{SS}+V_{Charge})+[(V_{DD}−V_{TH}_{_{—}}_{T5})−V_{Data}] due to the capacitive coupling effect of the voltage level V_{C} of the third node C. Accordingly, the current of the organic light emitting diode (OLED) can be derived from the equation below:

$${V}_{Gate \_ T 1} = {V}_{B} = ( {V}_{SS} + {V}_{Charge} ) + [ ( {V}_{DD} - {V}_{TH \_ T 5} ) - {V}_{Data} ] , \\ {V}_{source \_ T 1} = {V}_{DD} - {V}_{OLED} , \\ \begin{matrix}{I}_{OLED} = \frac{1}{2} * W / L * {μ}_{P} * {{C}_{OX} ( {V}_{SG \_ T 1} - {V}_{TH \_ T 1} )}^{2} \\ = \frac{1}{2} * W / L * {μ}_{P} * {C}_{OX} \{ [ - ( {V}_{DD} + {V}_{SS} ) ] - \\ [ {V}_{Charge} - ( {V}_{DD} - {V}_{TH \_ T 1} - {V}_{OLED} ) ] + \\ { {V}_{TH \_ T 5} + {V}_{Data} \}}^{2}\end{matrix} \qquad ( equation 3 )$$

In the foregoing equation 2 of the current I_{OLED} of the organic light emitting diode, V_{TH}_{_{—}}_{T1} increase, μ_{P} decrease and V_{OLED} increases; V_{DD}+V_{SS} can remains as a constant without the effect of the IR drop. However, the IR drop affects V_{DD} to be increased. The present invention can drop the charge current I_{Charge} to decrease the charge voltage V_{Charge}. Accordingly, the objective of compensating the current I_{OLED} can be realized. Consequently, the present invention can prevent the effect that the pixels at the different locations of the display have different currents I_{OLED} which is caused by the IR drop due to the larger size of the display. Furthermore, the present invention utilizes the characteristic that the threshold voltage V_{TH}_{_{—}}_{T5} of the fifth thin film transistor T5 increases with usage time, accordingly, the compensation of the OLED luminous efficiency drop can be realized.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A pixel circuit of an organic light emitting diode display, having a data line, an emit line and a scan line, respectively coupled to the pixel circuit and having an operating voltage and a grounding voltage provided thereto, the pixel circuit of the organic light emitting diode display comprising:
a first thin film transistor, employed as being a driving thin film transistor and having a first end and a second end, and the first end of the first thin film transistor is source;
an organic light emitting diode, having a first end and a second end, and the first end of the organic light emitting diode is anode to be coupled to the first end of the first thin film transistor to be driven by the first thin film transistor;
a second thin film transistor, having a first end and a second end, and a gate of the second thin film transistor is coupled to the emit line and the first end of the second thin film transistor is supplied with the operating voltage, and the second end of the second thin film transistor is coupled to the second end of the first thin film transistor where a first node is formed therebetween;
a third thin film transistor, having a first end and a second end, and a gate of the third thin film transistor is coupled to the scan line, and the first end of the third thin film transistor is coupled to the first node, and the second end of the third thin film transistor is coupled to a gate of the first thin film transistor where a second node is formed therebetween;
a fourth thin film transistor, having a first end and a second end, and a gate of the fourth thin film transistor is coupled to the scan line, and the first end of the fourth thin film transistor is coupled to the data line to control an input interval of the data line;
a fifth thin film transistor, having a first end and a second end, and a gate of the fifth thin film transistor is coupled to the emit line, and the first end of the fifth thin film transistor is coupled to the second end of the fourth thin film transistor where a third node is formed therebetween, and the second end of the fifth thin film transistor is coupled to the second end of the organic light emitting diode; and
a compensation capacitance, having a first end and a second end, and the first end of the compensation capacitance is coupled to the third node, and the second end of the compensation capacitance is coupled to the second node;
wherein the second thin film transistor initializes voltage levels of the first node and the second node to be maintained at the operating voltage, and the third thin film transistor saves a compensation voltage of the second node in the compensation capacitance, and the fifth thin film transistor constantly discharges to the first end of the compensation capacitance to maintain a voltage level of the third node.

2. The pixel circuit of an organic light emitting diode display according to claim 1, wherein the first thin film transistor is an N type thin film transistor.

3. The pixel circuit of an organic light emitting diode display according to claim 1, wherein the second, third, fourth and fifth thin film transistors are P type thin film transistors.

4. The pixel circuit of an organic light emitting diode display according to claim 1, wherein stress times of the first thin film transistor and the fifth thin film transistor are similar to utilize an increase of a threshold voltage of the fifth thin film transistor with time to compensate a decrease of a luminous efficiency of the organic light emitting diode.

5. A driving method of a pixel, employed for a pixel circuit having a data line, an emit line and a scan line, respectively coupled to the pixel circuit and having an operating voltage and a grounding voltage provided thereto, and the pixel circuit comprising a first thin film transistor, an organic light emitting diode, a second thin film transistor, a third thin film transistor, a fourth thin film transistor, a fifth thin film transistor and a compensation capacitance, and a first end of the first thin film transistor is coupled to the first end of the organic light emitting diode to drive the organic light emitting diode, and a second end of the second thin film transistor is coupled to the second end of the first thin film transistor wherein a first node is formed therebetween, and a second end of the third thin film transistor is coupled to a gate of the first thin film transistor where a second node is formed therebetween, and a first end of the fifth thin film transistor is coupled to a second end of the fourth thin film transistor where a third node is formed therebetween, and a first end of the compensation capacitance is coupled to the third node, and a second end of the compensation capacitance is coupled to the second node, the driving method comprising steps of:
providing the grounding voltage to the emit line and the scan line and conducting the first thin film transistor, the second thin film transistor, the third thin film transistor, the fourth thin film transistor and the fifth thin film transistor to initialize voltage levels of the first node and the second node to be maintained at the operating voltage;
providing the operating voltage to the emit line and cutting off the second thin film transistor and the fifth thin film transistor to provide a pixel data voltage to the data line to make the first node and the second node are discharged through the first thin film transistor and the organic light emitting diode; and
providing the operating voltage to the scan line and the grounding voltage to the emit line, and cutting off the third thin film transistor and the fourth thin film transistor, and conducting the second thin film transistor and the fifth thin film transistor to utilize the compensation capacitance for coupling the voltage level of the third node with the voltage level of the second node to be provided to the first thin film transistor for driving the organic light emitting diode.

6. The driving method of the pixel according to claim 5, further comprising a step of controlling the discharge within a predetermined interval to prevent the first node and the second node discharged completely in the step of cutting off the second thin film transistor and the fifth thin film transistor for discharge.

7. The driving method of the pixel according to claim 5, wherein the third thin film transistor saves a compensation voltage of the second node in the compensation capacitance as driving the organic light emitting diode for lighting.

8. The driving method of the pixel according to claim 5 wherein the fifth thin film transistor constantly discharges to the first end of the compensation capacitance to maintain a voltage level of the third node as driving the organic light emitting diode for lighting.

9. A pixel circuit of an organic light emitting diode display, having a data line, an emit line and a scan line, respectively coupled to the pixel circuit and having an operating voltage and a grounding voltage provided thereto, the pixel circuit of the organic light emitting diode display comprising:
a first thin film transistor, employed as being a driving thin film transistor and having a first end and a second end, and the first end of the first thin film transistor is source;
an organic light emitting diode, having a first end and a second end, and the first end of the organic light emitting diode is supplied with the operating voltage, and the second end of the organic light emitting diode is cathode to be coupled to the first end of the first thin film transistor to be driven by the first thin film transistor;
a second thin film transistor, having a first end and a second end, and a gate of the second thin film transistor is coupled to the emit line and the first end of the second thin film transistor is supplied with the grounding voltage, and the second end of the second thin film transistor is coupled to the second end of the first thin film transistor where a first node is formed therebetween;
a third thin film transistor, having a first end and a second end, and a gate of the third thin film transistor is coupled to the scan line, and the first end of the third thin film transistor is coupled to the first node, and the second end of the third thin film transistor is coupled to a gate of the first thin film transistor where a second node is formed therebetween;
a fourth thin film transistor, having a first end and a second end, and a gate of the fourth thin film transistor is coupled to the scan line, and the first end of the fourth thin film transistor is coupled to the data line to control an input interval of the data line;
a fifth thin film transistor, having a first end and a second end, and a gate of the fifth thin film transistor is coupled to the emit line, and the first end of the fifth thin film transistor is coupled to the second end of the fourth thin film transistor where a third node is formed therebetween, and the second end of the fifth thin film transistor is coupled to the first end of the organic light emitting diode; and
a compensation capacitance, having a first end and a second end, and the first end of the compensation capacitance is coupled to the third node, and the second end of the compensation capacitance is coupled to the second node;
wherein the second thin film transistor initializes voltage levels of the first node and the second node to be maintained at the grounding voltage, and the third thin film transistor saves a compensation voltage of the second node in the compensation capacitance, and the fifth thin film transistor constantly charges to the first end of the compensation capacitance to maintain a voltage level of the third node.

10. The pixel circuit of an organic light emitting diode display according to claim 9, wherein the first thin film transistor is a P type thin film transistor.

11. The pixel circuit of an organic light emitting diode display according to claim 9, wherein the second, third, fourth and fifth thin film transistors are N type thin film transistors.

12. The pixel circuit of an organic light emitting diode display according to claim 9, wherein stress times of the first thin film transistor and the fifth thin film transistor are similar to utilize an increase of a threshold voltage of the fifth thin film transistor with time to compensate a decrease of a luminous efficiency of the organic light emitting diode.

13. A driving method of a pixel, employed for a pixel circuit having a data line, an emit line and a scan line, respectively coupled to the pixel circuit and having an operating voltage and a grounding voltage provided thereto, and the pixel circuit comprising a first thin film transistor, an organic light emitting diode, a second thin film transistor, a third thin film transistor, a fourth thin film transistor, a fifth thin film transistor and a compensation capacitance, and a first end of the first thin film transistor is coupled to the first end of the organic light emitting diode to drive the organic light emitting diode, and a second end of the second thin film transistor is coupled to the second end of the first thin film transistor wherein a first node is formed therebetween, and a second end of the third thin film transistor is coupled to a gate of the first thin film transistor where a second node is formed therebetween, and a first end of the fifth thin film transistor is coupled to a second end of the fourth thin film transistor where a third node is formed therebetween, and a first end of the compensation capacitance is coupled to the third node, and a second end of the compensation capacitance is coupled to the second node, the driving method comprising steps of:
providing the operating voltage to the emit line and the scan line and conducting the first thin film transistor, the second thin film transistor, the third thin film transistor, the fourth thin film transistor and the fifth thin film transistor to initialize voltage levels of the first node and the second node to be maintained at the grounding voltage;
providing the grounding voltage to the emit line and cutting off the second thin film transistor and the fifth thin film transistor to provide a pixel data voltage to the data line to make the first node and the second node are charged through the first thin film transistor and the organic light emitting diode; and
providing the grounding voltage to the scan line and the operating voltage to the emit line, and cutting off the third thin film transistor and the fourth thin film transistor, and conducting the second thin film transistor and the fifth thin film transistor to utilize the compensation capacitance for coupling the voltage level of the third node with the voltage level of the second node to be provided to the first thin film transistor for driving the organic light emitting diode.

14. The driving method of the pixel according to claim 13, further comprising a step of controlling the charge within a predetermined interval to prevent the first node and the second node charged completely in the step of cutting off the second thin film transistor and the fifth thin film transistor for charge.

15. The driving method of the pixel according to claim 13, wherein the third thin film transistor saves a compensation voltage of the second node in the compensation capacitance as driving the organic light emitting diode for lighting.

16. The driving method of the pixel according to claim 13, wherein the fifth thin film transistor constantly charges to the first end of the compensation capacitance to maintain a voltage level of the third node as driving the organic light emitting diode for lighting.
